(19) United States
(12) Patent Application Publication
(10) Pub. No.: US 2026/0212353 A1
(43) Pub. Date: Jul. 23, 2026

(54) NETWORK PROTOCOL FOR A SUBSCRIPTION MANAGEMENT NETWORK

(71) Applicant: MASTERCARD ASIA/PACIFIC PTE. LTD., Singapore (SG)

(72) Inventors: Abhinava SRIVASTAVA, Singapore (SG); Sandeep MALHOTRA, Singapore (SG)

(21) Appl. No.: 19/031,299

(22) Filed: Jan. 17, 2025

(51) Int. Cl. G06Q 20/40; G06Q 20/10; H04W 4/12

(52) U.S. Cl. CPC G06Q 20/401; G06Q 20/102; H04W 4/12

(57) ABSTRACT

Examples manage subscription services in a payment network, including receiving a recurring indicator request message associated with a recurring transaction in a subscription, the recurring indicator request message being a request for approval to submit an authorization request for the subscription; transmitting a notification message to a user computing device associated with the subscription, the notification message requesting user consent to process a next recurring transaction for the subscription; receiving first user input from the user computing device in response to the notification message, the first user input identifying an approval of a next recurring transaction; and transmitting a recurring indicator response message, the recurring indicator response message providing an indication of approval to proceed with submission of an authorization request for the next recurring transaction.

### BACKGROUND

Subscription management software helps consumers organize and track their recurring payments for various services. With subscription-based models of payment, it can be difficult for individuals to keep track of all their services. Many of these services connect directly to the consumer's financial accounts to identify recurring charges. Some conventional tools help consumers track their active subscriptions, highlight overlooked or unwanted services, and perhaps provide certain ways to cancel unwanted subscriptions. Some platforms also offer bill negotiation, where the subscription management service works directly with the subscription service providers to reduce monthly payments, taking a percentage of any savings as a fee. Additionally, some manual tracking apps are available. Such apps allow individuals to input their subscriptions, giving a simple overview of all their recurring payments in one place, without needing to link financial accounts.

Such subscription management tools aim to streamline the process of handling multiple services and their associated recurring charges, providing users with a clearer picture of their expenses, options to cancel unwanted subscriptions, and potential savings through optimizations.

### SUMMARY

An example subscription management network (SMN) provides three core capabilities: (A) an authentication service enables and manages consumer authentication and consumer consent capture during setup for requested subscription; (B) a notification service enables communication and consent management to the consumers for upcoming subscription charges; and (C) a payment service that, during authorization, validates if the consumer consented for upcoming subscription charge.

Some examples provide a subscription management network comprising: at least one processor; and at least one memory comprising computer-readable instructions, the at least one processor, the at least one memory and the computer-readable instructions configured to cause the at least one processor to: receive a first message associated with a recurring transaction in a subscription, the first message being received prior to receiving an authorization request for the recurring transaction, the first message being a request for approval to submit the authorization request for the recurring transaction; transmit a notification message to a user computing device associated with the subscription, the notification message identifying one or more of a merchant associated with the recurring transaction and a transaction amount of the recurring transaction; receive first user input from the user computing device in response to the notification message, the first user input identifying an approval of the recurring transaction; and transmit a second message in response to the first message, the second message providing an indication of approval to proceed with submission of the authorization request for the recurring transaction.

Some examples provide a computer-implemented method for managing subscription services in a payment network, the method comprising: receiving a recurring indicator request message associated with a recurring transaction in a subscription, the recurring indicator request message being a request for approval to submit an authorization request for the subscription; transmitting a notification message to a user computing device associated with the subscription, the notification message requesting user consent to process a next recurring transaction for the subscription; receiving first user input from the user computing device in response to the notification message, the first user input identifying an approval of a next recurring transaction; and transmitting a recurring indicator response message, the recurring indicator response message providing an indication of approval to proceed with submission of an authorization request for the next recurring transaction.

Some examples provide a computer storage medium having computer-executable instructions that, upon execution by a processor of a computer, cause the processor to at least: receive a first message associated with a recurring transaction in a subscription, the first message being received prior to receiving an authorization request for the recurring transaction, the first message being a request for approval to submit the authorization request for the recurring transaction; transmit a notification message to a user computing device associated with the subscription, the notification message identifying one or more of a merchant associated with the recurring transaction and a transaction amount of the recurring transaction; receive first user input from the user computing device in response to the notification message, the first user input identifying an approval of the recurring transaction; and transmit a second message in response to the first message, the second message providing an indication of approval to proceed with submission of the authorization request for the recurring transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an architecture and data flow diagram for an example system including a network protocol for managing subscriptions between merchants and users on a payment network.

FIG. 2 is an architecture and data flow diagram for a subscription management network and network protocol, such as the example shown in FIG. 1.

FIG. 3 is a sequence diagram illustrating operations for an example process and network protocol for establishing a new subscription with the subscription management network (SMN).

FIG. 4 is a sequence diagram illustrating operations for an example process and network protocol for performing a transaction authorization for an existing subscription with the SMN.

FIG. 5 is a flowchart of an exemplary method for managing subscription services in a payment network.

FIG. 6 is a functional block diagram of a computing apparatus according to an embodiment.

Corresponding reference characters indicate corresponding parts throughout the drawings. Any of the figures may be combined into a single example or embodiment.

### DETAILED DESCRIPTION

Conventional subscription management software (SMS) services provide some utility but have numerous drawbacks. For example, when a user wishes to cancel a subscription, the SMS may not be able to perform the cancellation automatically. Some SMS services are directly integrated with certain service providers and can perform the cancellation with the integrated services. However, any cancellation with third-party services may need to be done manually by the user. Some SMS services aid the user in engaging with customer support of the subscription service they would like to cancel. Even with assistance from the SMS, the user may still deal with a possibly convoluted or confusing cancelation process for each subscription.

In contrast, an example subscription management network (SMN) introduces a network protocol used to establish and manage recurring payments on a payment network. The SMN integrates directly within network message flows between merchants, issuers, and the payment network to facilitate both the initial establishment of subscriptions, as well as messaging and managing user consent and/or cancellation of recurring payments prior to later recurring transactions for those subscriptions. This direct integration of the SMN into network messaging on the payment network allows the SMN to improve the network with a protocol for subscription-based services.

More specifically, in examples, this network protocol adds a mandate request and response during initial user authentication (e.g., leveraging Identity Check Service, Biometrics, Mastercard Payment Passkeys or OTP) on the payment network. For example, when a user first signs up for an ongoing service (e.g., a monthly subscription to an online content provider, a quarterly gym membership, or the like), an authentication request (“AREQ”) message is sent to the payment network with a “subscription” flag enabled. The payment network is configured to redirect such flagged messages to the SMN (e.g., in lieu of normal message processing). When establishing an initial subscription, the SMN performs a mandate request and response with the user (e.g., via the merchant payment processing system). A mandate request message (“MREQ”) is sent back to the merchant for presentation to the user (e.g., while the user is present with the merchant). This mandate request summarizes, for the user, the details of the subscription for which they are about to enroll, such as a recurrence interval (e.g., how often they will incur additional charges) and a recurring amount (e.g., the amount of those additional periodic charges). The mandate request is presented to the user via the merchant during the initial setup (e.g., via an online shopping system or payment gateway for online transactions or mobile app transactions, via a point-of-sale device at a brick-and-mortar store, or the like). The user, in turn, provides their consent (or refusal) to establish this recurring subscription through a mandate response message (“MRES”) sent from the merchant back to the SMN.

Upon receipt of affirmative consent in the mandate response, the SMN stores a mandate record for this ongoing subscription. This mandate record stores an affirmation of this initial consent of the user (e.g., initial consent creation step) and is updated with additional data during subsequent operations. In response to the affirmative consent, the SMN continues this initial authentication of the user based on the payment credential provided for this initial transaction. In scenarios where the user has provided a payment credential (e.g., network token), the SMN sends the AREQ message on to the issuing bank associated with that payment card, thereby allowing the issuing bank to authenticate the cardholder. For some transactions (e.g., higher risk transactions, or “challenge flow” transactions), the issuer prompts the cardholder to provide additional data to verify their identity before authenticating the cardholder, such as leveraging Identity Check Service, Biometrics, Mastercard Payment Passkeys or OTP (e.g., providing biometric authentication, answering a security question, providing a one-time password, or the like). For other transactions (e.g., lower risk transactions, or “frictionless” transactions), the issuer evaluates this initial transaction as low risk and authenticates the cardholder without needing further cardholder verification. As such, the issuer responds to the AREQ with an authentication response message (“ARES”), where the ARES includes an authentication value (“AV”) (e.g., an account authentication value (“AAV”), or the like, to be used for this initial transaction) and a consent service ID (“CSID”) (e.g., a unique identifier generated by the SMN for this subscription and associated user consent).

In examples, this ARES message is sent back through the SMN and on to the merchant, thereby allowing the merchant to use the CSID and AV during authorization of the initial transaction. Further, as the SMN receives and passes on the ARES message to the merchant, the SMN also saves a copy of the AV, updating the mandate record associated with this subscription with the AV provided by the issuer. This AV may be used in subsequent recurring transactions associated with this subscription.

After authentication and authorization of the initial transaction for this subscription, the merchant and user have thus established a new subscription via the SMN. When the next periodic payment for this subscription is coming due (e.g., 24 hours before the next recurring transaction would normally occur), the merchant sends a preemptory message to the SMN for this subscription, namely a “recurring indicator request” (“RIREQ”). This RIREQ includes the AV and CSID generated during the initial consent creation process. Upon receipt, the RIREQ alerts the SMN that the merchant is planning to submit a recurring transaction for this subscription during the upcoming day. In response, the SMN sends a notification message to the user (e.g., via SMS text message, email, app notification, or the like), thereby alerting the user of this upcoming recurring transaction. Further, in examples, this notification message allows the user to respond with an approval for this transaction or a cancellation of this subscription. If the user elects to cancel this subscription, the SMN sends a notice of cancellation of this subscription to the merchant, updates the mandate record with a canceled status, and subsequently declines all recurring transactions associated with this subscription (e.g., if the merchant 110 accidentally or maliciously submits another transaction to this subscription). If the user expressly approves this transaction (e.g., via an affirmative response to the notification), or if the user does not respond to the notification within a timeout period (e.g., presumed as a tacit approval), then the SMN sends an affirmative notice to the merchant (e.g., in a recurring indicator response message, “RIRES”), thereby indicating to the merchant that they are authorized to continue with an authorization request for this next recurring payment. Further, in examples, the SMN also sends the AV of the subscription along with the RIRES, thereby allowing the merchant to include the AV in the authorization request.

Accordingly, the merchant submits an AREQ (with the AV) for this recurring payment to the payment network and on to the issuer, allowing the issuer to authorize (or decline) the recurring transaction. As such, the SMN provides a networking protocol that facilitates establishing a subscription between the merchant and the user, as well as for alerting the user prior to upcoming recurring payments for that subscription, allowing in-network mechanisms for approving or cancelling recurring payments for such subscriptions.

A conventional computing device operates in an unconventional manner by implementing a new network protocol to manage subscriptions and their associated recurring transactions on a payment network. The system including the SMN described herein reduces network traffic and computing resources utilization by reducing the number of transaction reversals that occur when users discover that they have been subject to unwanted recurring transactions. Prior to submitting a recurring transaction, the merchant system sends a recurring indicator request message to a subscription management network. The SMN transmits a notification message to the user to acquire their consent for the next recurring transaction. Upon user approval, the SMN transmits a recurring indicator response message to the merchant system, providing an indication of approval to proceed with submission of an authorization request for the next recurring transaction. This protocol of notifying the user and getting approval before performing the recurring transaction reduces computational burden and additional network messages associated with unwanted recurring transactions and their reversals, thereby improving the functioning of the underlying computing device.

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, ...” For brevity and clarity of presentation, this implied leading clause is not repeated ad nauseum.

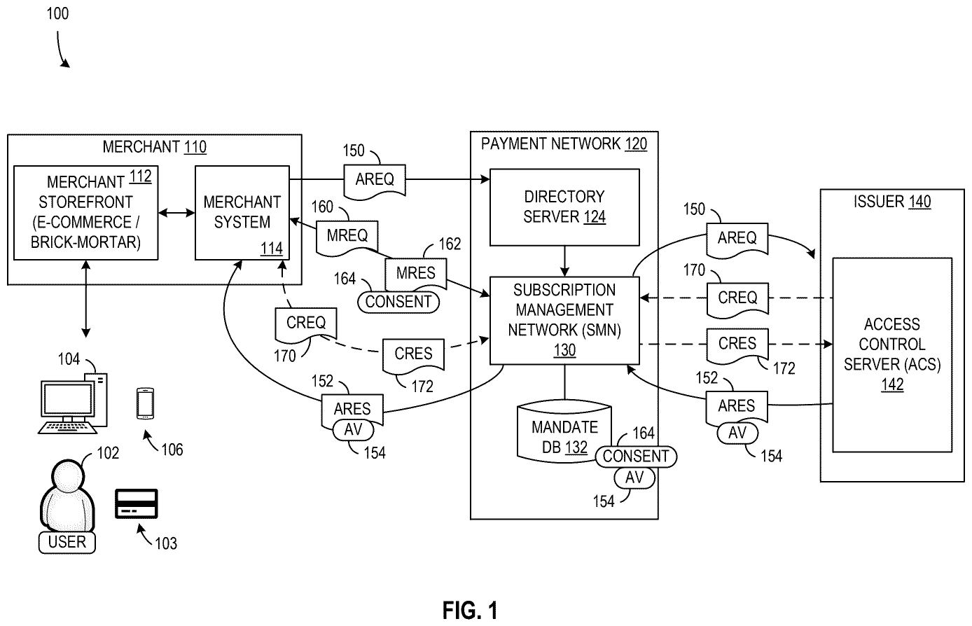

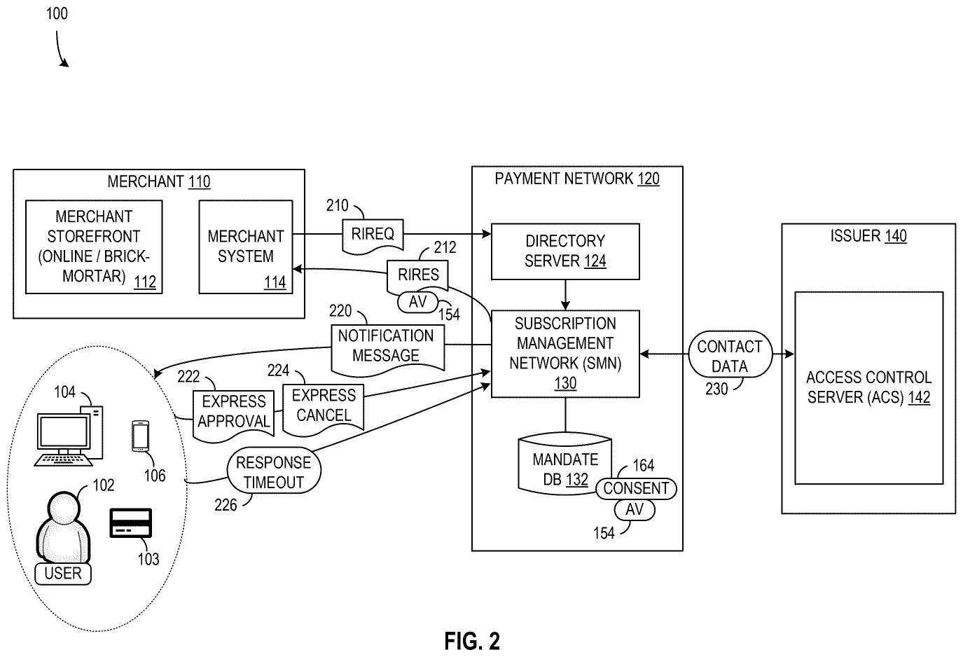

FIG. 1 is an architecture and data flow diagram for an example system 100 including a network protocol for managing subscriptions between merchants 110 and users 102 on a payment network 120. In the example, the system 100 includes an SMN 130 (e.g., a computing device, server, cloud computing service, or the like) that integrates with the payment network 120 to facilitate this novel network protocol. In examples the system includes three core capabilities: (A) an authentication service enables and manages consumer authentication and consumer consent capture during setup for requested subscription; (B) a notification service enables communication and consent management to the consumers for upcoming subscription charges; and (C) a payment service that, during authorization, validates if the consumer consented for upcoming subscription charge. FIG. 1 illustrates aspects of these services and a supporting network protocol, as well as the functionality performed by the SMN 130 that are provided during setup of a new subscription between the user 102 and the merchant 110 and the associated authentication and authorization of an initial transaction for that subscription. Likewise, FIG. 2 illustrates aspects of this network protocol that are provided during, and just prior to, authorization of subsequent recurring transactions for that subscription.

Referring now to FIG. 1, in the example, the user 102 is interacting with the merchant 110 via a merchant storefront 112 (e.g., a brick-and-mortar store, an online marketplace of the merchant via web, mobile app, or the like) to initiate a subscription with the merchant 110 (e.g., for an ongoing service, product(s)). For example, presume the user 102 is signing up for an ongoing content service provided by the merchant 110 (e.g., a streaming service or a video-on-demand service), or the user 102 is signing up for a periodic meal kit delivery service with the merchant. Such subscription-based services involve an ongoing relationship between the user 102 and the merchant 110 (e.g., the “subscription”).

Further, such subscriptions typically have a recurrence interval (e.g., how long a single payment sustains the subscription, how often the user 102 will be expected to pay) and a recurring amount (e.g., a transaction value expected to be paid at every recurrence interval). For example, the streaming service may be a monthly service for $20/month. The meal kit delivery service may be subscribed as a weekly service for two people at three meals per week for a cost of $60/week. It should be understood that the term “merchant” is used to refer to any biller entity that may perform recurring transactions with their users, whether for products or services. As such, “merchants” can include, for example, consumer goods and service retailers, online service providers, utilities, telecommunication, healthcare providers, government agencies, and the like. Likewise, “subscription services” and their associated “recurring transactions” can include, for example, gym memberships, scheduled product purchases (e.g., monthly pet food purchases), monthly or quarterly residential electric, gas, water, cellphone or internet service, yearly health checkups or dentist visits, yearly property tax payments, or the like.

During the initial setup of the example subscription, the user 102 presents a payment credential (e.g., a network token) to be used for the subscription. In this example, the user 102 enters credentials for a payment card 103 (e.g., network token, expiry, cryptogram, and the like). To establish the subscription for the user 102 and to initiate the first transaction in a series of recurring transactions for that service, the merchant 110 performs both an authentication process and an authorization process. The authentication process verifies the identity of the user 102 (e.g., ensuring that the user 102 is authorized to use the particular payment credential presented) leveraging an identity check service, biometrics, one-time password (OTP), or a system as Mastercard Payment Passkeys. The authorization process verifies that the user 102 (e.g., the cardholder, the account holder) has sufficient funds or credit available in an underlying account associated with the payment credential presented and that the transaction is approved by the account holder (e.g., an issuer 140 of the payment card 103). It should be understood that the data flow shown in FIG. 1 illustrates the network protocol associated with the authentication process during initial setup of the subscription (e.g., prior to authorization of the first transaction) but, for purposes of clarity, the authorization process and associated messages between the various parties are not expressly shown in FIG. 1.

In the example, the merchant 110 utilizes a merchant system 114 that allows the merchant 110 to perform transactions on the payment network 120, including transactions for the subscription as described herein. The merchant system 114 includes both hardware (e.g., computing resources, computing devices, networking hardware, point-of-sale (POS) devices, server/hosting infrastructure, and the like) and software (e.g., payment network client, payment gateway, e-commerce platform/middleware). It should be understood that the merchant system 114 shown in FIG. 1 and FIG. 2 is a distilled representation of the software and hardware that allows the merchant 110 to participate in the payment network 130 sufficient to enable the systems and methods described herein, and may be operated in part by the merchant 110 or other related parties, such as payment gateways, or acquiring banks. Any such architecture that enables the systems and methods described herein may be used.

During the example authentication process shown in FIG. 1, the merchant system 114 begins the establishment of a subscription by submitting an authentication request message (“AREQ”) 150 to a directory server 124 of the payment network 120. AREQ 150 includes payment credential information, transaction information, and other data that is used (e.g., by the issuer 140) to assess risk in the transaction and to determine appropriate authentication flow. In examples, the AREQ 150 includes the card number of the payment credential (e.g., PAN, FPAN, tokenized PAN of the payment card 103, account number, or the like), merchant information (e.g., merchant name, merchant ID, merchant country code), transaction information (e.g., total value of the first transaction, currency code, merchant category code (MCC)), as well as additional information that can be used to assess potential risk in the transaction, such as device ID, IP address, or device fingerprinting data of a device used by the user 102 (e.g., user computing device 104, mobile computing device 106), and the like.

Further, in this example, the AREQ 150 also includes several data components that are relative to recurring transactions and that are used by the SMN 130 to establish a new subscription. First, the AREQ 150 includes a recurring indicator flag that is set to true (e.g., recurringIndicator=TRUE), expressly identifying this AREQ 150 as being associated with a recurring transaction series. This and all subsequent AREQs 150 sent by the merchant 110 for this subscription will include this flag set to true. Next, this first AREQ 150 includes a transaction type or transaction count field that identifies this AREQ 150 as being the first in this series, or as being associated with a setup of a new subscription (e.g., transactionType=01, recurringTranCount=1, or the like). Based on the recurringIndicator set to TRUE an the transactionType=1, other participants in the payment network 120 can determine that this AREQ 150 is associated with a first transaction in a new recurring payment series (e.g., a new subscription).

In addition to the above indicators, the AREQ 150 also includes recurring payment data identifying attributes of the subscription with which the user 102 is enrolling. More specifically, in examples, the AREQ 150 also includes a recurring frequency or billing cycle length identifying how often the user 102 will be subject to a new payment (e.g., recurringFrequency=7 days, 30 days, 90 days, or the like), as well as a transaction amount and/or a recurring transaction amount indicating how much the user 102 is paying for the first transaction and for subsequent transactions in the subscription. In some examples, the AREQ 150 also contains tenure information for the subscription (e.g., transaction context indicating length of time the subscription has been active between this user and merchant, risk assessment data, merchant assessment data, or the like), the service name associated with the subscription (e.g., identifying what product or service is provided by the merchant 110 for this subscription), and/or the variability of amount.

In the example, the AREQ 150 is initially sent to a directory server 124 of the payment network 120. The directory server 124 is responsible for routing of certain messages within the payment network 120. In the case of the example AREQ 150, the directory server 124 determines which issuer 140 is associated with the payment credential (e.g., the payment card 103) included in the AREQ 150 (e.g., using the bank identification number (BIN)/issuer identification number (IIN) range of the PAN of payment card 103). As such, the payment network 120 identifies an access control server (ACS) 142 that handles authentication and authorization of transactions for that issuer 140 (e.g., issuer ID of the issuer 140, endpoint URL of the ACS 142, or the like).

In the case of non-recurring transactions, the directory server 124 routes authentication and authorization requests through to the issuer 140. However, in the case of recurring transactions, the directory server 124 instead routes such traffic to the SMN 130.

More specifically, in this example, the directory server 124 inspects the AREQ 150 for the recurring data elements discussed above. When the directory server 124 identifies that the AREQ 150 includes the recurringIndicator flag set to TRUE, the directory server 124 routes the AREQ 150 to the SMN 130, along with issuer and ACS data identified for this AREQ 150 (e.g., as supplemental data added to the AREQ 150).

Upon receipt of the AREQ 150, the SMN 130 inspects the recurring data elements of the AREQ 150. More specifically, in the example, the SMN 130 identifies that this AREQ 150 is an initial authentication request for a new subscription (e.g., based on transaction Type=01 or recurring TranCount=1). The SMN 130 also identifies attributes of the new subscription from the AREQ 150, such as the recurring frequency and the transaction amount.

As such, for new subscriptions, the SMN 130 generates and sends a mandate request message (“MREQ”) 160 back to the merchant system 114. This MREQ 160 includes the recurring frequency and the transaction amount. The MREQ 160 serves as an additional notice to the user 102 that they are about to sign up for a new subscription, allowing the user 102 to expressly consent to this new subscription or cancel before this first transaction is complete. In examples, receipt of the MREQ 160 prompts the merchant system 114 to display the recurring frequency and the transaction amount to the user 102 (e.g., via POS device, online e-commerce site, mobile app, or the like) along with a consent prompt for the user 102 to either accept or decline.

After receiving user input from the user 102, the merchant system 114 transmits a mandate response message (“MRES”) 162 back to the SMN 130. In situations where the user 102 declines the consent prompt from the MREQ 160, the SMN 130 cancels the setup of a new subscription and responds to the AREQ 150 with an authentication response message (“ARES”) 152 that cancels the AREQ 150 to the merchant system 114.

In situations where the user 102 accepts the consent prompt of the MREQ 160, as in the example shown here, the MRES 162 includes an affirmative consent 164 from the user 102. Upon receipt of this consent 164, the SMN 130 generates a new “mandate record” in the mandate DB 132 for this subscription. This mandate record initially includes the affirmative consent 164, as well as other data associated with the subscription, such as the merchant ID, recurring interval, recurring amount, and the like.

At this stage, the SMN 130 continues with the authentication process for this initial transaction. In this example, the SMN 130 sends the AREQ 150 through to the issuer 140 and the ACS 142 for authentication of the user 102 and their payment credential. In some situations, the ACS 142 initiates a challenge flow for this transaction, sending a challenge request message (“CREQ”) 170 back through to the merchant system 114 for additional input from the user 102, and the merchant system 114 responds with a challenge response message (“CRES”) 172 back to the ACS 142. In the example, the CREQ 170 and CRES 172 are passed through the SMN 130, where in other examples, the ACS 142 may communicate directly with the merchant system 114 for these communications. In other situations, the ACS 142 does not initiate a challenge flow, and instead proceeds directly with an authentication response message (“ARES”) 152.

In this example, whether the authentication is a “frictionless” authentication (e.g., not performing the CREQ 170 and CRES 172) or a “challenge flow” authentication (e.g., necessitating a successful CREQ 170 and CRES 172), it is presumed that the AREQ 150 results in a successful authentication of the user 102 and the payment credential provided in the AREQ 150. Upon successful authentication at the issuer 140, the ACS 142 generates an authentication value (“AV”) 154 for this AREQ 150 and includes that AV 154 in the ARES 152 that is sent back to the merchant system 114. This authentication value, in the example, is a cryptographic token generated by the ACS 142 specific to this transaction, containing specific data elements that ensure the security, integrity, and authenticity of the authentication process (e.g., an account authentication value (AAV), a cardholder authentication verification value (CAVV), or the like).

In this example, the ARES 152, along with the AV 154, is sent through the SMN 130 enroute to the merchant system 114. Upon receipt of the ARES 152, the SMN 130 updates the mandate record for this transaction with the AV 154 included in the ARES 152. The SMN 130 forwards on the ARES 152 and AV 154 to the merchant system 114, thereby verifying a successful authentication. In situations where the AREQ 150 fails authentication, the SMN 130 updates the mandate record to indicate an unsuccessful authentication or deletes the mandate record from the mandate DB 132, thereby cancelling this subscription attempt.

While not shown in FIG. 1, after receipt of the ARES 152 in a successful authentication, the merchant system 114 continues with a payment authorization process for the first transaction in this subscription. For example, the merchant system 114 generates an authorization request for the first installment in this recurring transaction (e.g., a first month payment of $20 to the streaming service, a first week payment of $60 to the meal kit delivery service, or the like). In some examples, this first transaction amount (and possibly others) may be different than the recurring transaction amount identified for the recurring payments (e.g., first three months free, first six meals free). In this example, the first transaction is treated as a “cardholder initiated transaction (CIT),” as the user 102 actively provides their payment credential during the authentication and authorization process, and is available to participate in both the mandate process (e.g., the MREQ 160 and MRES 162) and the authentication process (e.g., in cases of challenge flow, the CREQ 170 and CRES 172).

The authorization request and subsequent authorization response from the issuer 140 for this initial payment authorization does not directly implicate the services provided by the SMN 130 and, as such, are not discussed in any greater detail here. For purposes of this example, it is presumed that the authorization process for the first transaction is successfully performed with the issuer 140, and using the AV 154 provided during the authorization process shown here. In some examples, the merchant system 114 stores the payment credential information for this subscription, where in other examples, the payment credential information is stored at the payment network 120 (e.g., in the mandate record for this subscription).

In some examples, a transaction ID is generated for this first transaction and is included in the various messages shown in FIG. 1, thereby allowing the participants to uniquely identify this particular transaction (e.g., in the AREQ 150 and ARES 152, in the CREQ 170 and the CRES 172, and in the MREQ 160 and the MRES 162), both during the authentication process and the authorization process. In some examples, the SMN 130 generates a subscription consent ID (“CSID”) during initial subscription consent. The CSID is a unique identifier that is associated with this particular subscription between user 102 and merchant 110. In some examples, the SMN 130 stores this transaction ID and/or CSID in the mandate record and uses the transaction ID as a unique identifier to find the mandate record for this particular subscription. Further, it is presumed that the merchant system 114 retains the transaction ID and/or CSID of this first transaction, as well as the payment credential provided by the user 102 during this first transaction. Both the transaction ID, the CSID, and the payment credential are used during later recurring payments and their associated authorization requests, as shown and described below.

While the example shown in FIG. 1 has the user 102 using the payment card 103 as the payment credential for the first transaction in this subscription, it should be understood that other types of payment credential can be used and are supported by the subscription management network. For example, the payment credential can be a credit card, a debit card, a bank account, a digital wallet (e.g., with links to other payment sources such as credit cards, debit cards, bank accounts), a cryptocurrency account or wallet, a stored value account (e.g., gift card, merchant credit, loyalty coupons), tokenized account, or the like. As such, the issuer 140 represents the manager of that payment source and is presumed to be participating in this payment network 120 and the SMN 130 sufficient to enable the systems and methods described herein.

In the example shown in FIG. 1, the MREQ 160 and MRES 162 messages are sent to the user 102 via the merchant system 114 (e.g., presented to the user 102 via the e-commerce site, POS device, or whatever venue through which the user 102 interacts with the merchant 110). In other examples, the SMN 130 may interact more directly with the user 102 for mandate consent. For example, the SMN 130 may transmit the MREQ 160 to the user computing device 104 or mobile device 106 via an email to the user 102, an SMS text message to a mobile phone number of the mobile device 106 of the user 102, or an app alert via an app installed on the mobile device 106 of the user 102. The MREQ 160 is thus treated as an alert of a new subscription initiation, similarly allowing the user 102 to provide user input indicating consent or refusal of this MREQ 160, and similarly causing the MRES 162 to be sent back to the SMN 130 with that consent 164 or refusal.

FIG. 2 is an architecture and data flow diagram for the example system 100 and a continuation of the network protocol shown in FIG. 1. In the example, FIG. 2 illustrates aspects of this network protocol and the functionality performed by the SMN 130 that are provided prior to (e.g., in preparation for) submission of a recurring payment for an existing subscription (e.g., the example subscription established in FIG. 1). As such, in this example, it is presumed that a subscription has already been established for this user 102 with the merchant 110, the first transaction has already been authenticated and authorized (e.g., as shown and described in FIG. 1), and the merchant 110 is preparing to initiate some subsequent recurring transaction against that subscription (e.g., as a merchant initiated transaction (MIT) using the stored payment credential of the user 102).

In the example, the network protocol involves the merchant system 114 sending an advanced notice of an upcoming recurring transaction to the SMN 130, thereby allowing the SMN 130 to notify the user 102 prior to the submitting the recurring transaction for this subscription. More specifically, the merchant system 114 is configured to create and transmit a recurring indicator request message (“RIREQ”) 210 at a predetermined amount of time (a “lead time”) before the next upcoming recurring transaction. For example, 24 hours before the next payment is due (e.g., when the merchant system 114 would typically transmit the authorization request for the next recurring transaction), the merchant system 114 sends the RIREQ 210 to the payment network 120. The RIREQ 210 includes identifying information for the subscription, such as the transaction ID of the first transaction associated with this series of recurring transactions and/or the CSID associated with this subscription, the merchant ID of the merchant 110, a subscription ID associated with this subscription, and the payment credential used for the series of recurring transactions (e.g., the card-on-file data the merchant system 114 stored when the subscription was initially established), as well as the recurringIndicator flag set to TRUE, a transaction type or transaction count field that identifies this transaction as not being the first in this series (e.g., transactionType=02, recurringTranCount=2 or more), and perhaps data about the upcoming recurring transaction (e.g., transaction amount, planned transaction submission date/time). This RIREQ 210 serves as an advanced notice of an upcoming scheduled recurring transaction for this subscription.

Like the AREQ 150 of FIG. 1, the RIREQ 210 is also sent to the directory server 124 and inspected for the recurringIndicator flag as TRUE, thereby causing the directory server 124 to redirect this RIREQ 210 to the SMN 130. Upon receipt by the SMN 130, the SMN 130 identifies that this RIREQ 210 is intended to be for a current (e.g., already established) subscription (e.g., based on the transactionType=02, recurringTranCount=2+) and thus looks up the mandate record for this subscription in the mandate DB 132 (e.g., by transaction ID, CSID, or the like). If no subscription is found, the SMN 130 responds to the merchant system 114 with a rejection notification in a recurring indicator response message (“RIRES”) 212. Further, if the merchant system 114 subsequently submits an authorization request for a recurring transaction a subscription that is not found, the SMN 130 declines that transaction authorization.

In the example, it is presumed that the SMN 130 identifies the example mandate record for this subscription in the mandate DB 132 (e.g., using the transaction ID of the first transaction, using the CSID provided in the RIREQ 210). As such, the SMN 130 proceeds to generate a notification message 220 for transmission to the user 102. The notification message 220 represents an alert to the user 102 about an upcoming recurring transaction under this subscription, giving the user 102 an opportunity to consider whether they wish to continue this subscription or cancel the subscription before the next recurring transaction is made.

In some examples, the SMN 130 stores contact data for the user 102 in the mandate record. For example, the mandate record may store an email address of the user 102, a mobile phone number or other device information of the mobile device 106 of the user 102, or the like). In some examples, the issuer 140 stores contact data 230 of the user 102 and the SMN 130 requests and retrieves that contact data 230 from the issuer 140. This contact data is used to target the user 102 with the notification message 220.

In the example, the notification message 220 is a communications pathway that allows both display messaging from the SMN 130 to the user 102 as well as provides a method of receiving response options from the user 102. In examples, the display messaging describes that this notification message 220 is regarding an active subscription between the user 102 and the merchant 110 (e.g., identified based on merchant ID stored in the mandate record or provided in the RIREQ 210), a notification that an upcoming recurring payment is planned (e.g., in 24 hours), as well as instructions on how to respond to this message 220 to accept or cancel this subscription, and perhaps a notice that this recurring payment will be performed if the user 102 does not respond to this message 220 (e.g., after 24 hours has elapsed from receiving this message 220). In some examples, this notification message 220 is sent to the user 102 via email and the SMN 130 monitors for a response email from that user 102 (e.g., with transaction ID and/or CSID in the subject line), parsing the email content for keywords indicating approval or cancellation (e.g., APPROVE, YES, PROCEED for the approval option, CANCEL, NO, STOP for the cancellation option). In some examples, this notification message 220 is sent to the user 102 via SMS text message, where the text message provides quick selection options for these two options (e.g., “1” to accept, “2” to cancel, or the like), and the SMN 130 parses the response text for the selection. In some examples, the SMN 130 sends the notification message 220 via a messaging system integrated into an app that is installed on the mobile device 106 of the user 102, where the app message presents the approval and cancellation response options to the user 102, and the app sends the response back to the SMN 130.

In the example, the notification message 220 results in four possible scenarios for user response, three of which are shown in FIG. 2. If the user 102 does not respond to the notification message 220 after a timeout period (e.g., after 24 hours from the time the message 220 was sent), then the SMN 130 considers this notification as timed out (identified as “response timeout 226” in FIG. 2) and proceeds as if the user 102 has approved the next recurring payment (e.g., based on the consent 164 previously provided and stored in the mandate record). Likewise, if the user 102 responds with an affirmative response (e.g., express approval 222), then the SMN 130 also proceeds with user approval for the next recurring payment. If the user 102 responds with a negative response (e.g., express cancel 224), then the SMN 130 cancels the subscription and refuses subsequent recurring payment transactions for this subscription. If the user 102 responds to the notification message 220 with a response that is not recognized as either affirmative or negative (e.g., if the response does not match one of the keywords provided, perhaps through a typo or mistake during response by the user 102), then the SMN 130 may take corrective action (e.g., retransmitting the notification message 220, indicating that the response is not a valid option, or the like) or may ignore the failed response (e.g., treating the message 220 as a response timeout 226 if no further correct response is received from the user 102 before the timeout period).

In situations where the user 102 responds to the notification message 220 with the express cancel 224 option, this causes the SMN 130 to both cancel this subscription (e.g., within the mandate DB 132) as well as notify the merchant system 114 of the express cancel 224. In the example, the SMN 130 updates the mandate record of this subscription with a “cancelled” status and stores a timestamp for this express cancel 224 (e.g., indicating a date/time when the user 102 expressly cancelled this subscription). As such, any later-received recurring transaction authorization requests associated with this subscription will be declined by the SMN 130 based on this cancellation status. Further, the SMN 130 creates and transmits a recurring indicator response message (“RIRES”) to the merchant system 114 (e.g., in response to the RIREQ 210) that includes a cancellation notice for this subscription. Accordingly, in examples, the merchant system 114 is configured to automatically cancel the subscription for this user 102, and thus to cancel submission of any future recurring payments for this subscription.

In situations where the user 102 either responds with the express approval 222 or does not respond within the timeout period (e.g., response timeout 226), the SMN 130 proceeds with approval of this RIREQ 210. More specifically, in examples, the SMN 130 updates the mandate record for this subscription based on the particular user response and timestamp (e.g., expressly approved at timestamp, implicit approval after response timeout at timestamp, or the like). Further, the SMN 130 creates and transmits an affirmative response to the merchant 114 in the RIRES 212, indicating that the merchant 114 has approval to continue with submission of the next recurring transaction for this subscription. In the example, the RIRES 212 includes the AV 154 stored in the mandate record for this subscription. This allows the merchant system 114 to include the AV 154 in the authorization request for this next recurring transaction.

Though not shown in FIG. 2, upon receipt of an affirmative response in the RIRES 212, the merchant system 114 prepares and submits an authorization request to the payment network 120 and through to the ACS 142 of the issuer 140. This transaction is considered a merchant-initiated transaction (MIT), as the user 102 is not present and able to participate at the time the transaction is submitted. In examples, the merchant system 114 includes the payment credential stored for this user 102 and the associated subscription (e.g., PAN, token, or the like). In other examples, the SMN 130 stores the payment credential for this subscription and adds the payment credential information to the authorization request before passing the authorization request on to the issuer 140. Further, in examples, the authorization request also includes the AV 154 provided in the RIRES 212, thus causing a liability shift from the merchant 110 to the issuer 140 (e.g., as an authenticated transaction). This example protocol thus introduces authentication into the MIT-type recurring transactions.

Accordingly, the issuer 140 either approves or declines this example recurring transaction, and thus the recurring transaction (already expressly or implicitly approved by the user 102) is processed by the issuer 140 for this recurring transaction. In some examples, if the issuer 140 declines the transaction, the SMN 130 and/or the merchant system 114 transmits another notification message to the user 102 indicating that the transaction has been declined, and may allow the user 102 to enter new payment credential information for a resubmission of another authorization request (perhaps to a different issuer 140, depending on the new credential), or may allow the user 102 to resubmit/retry this recurring transaction with the same payment credential (e.g., after the user 102 adds funds to a stored value account, makes a payment to expand available credit on a payment card account, or the like).

In examples, the SMN 130 maintains a status flag (e.g., “recurringTransAllowed”) for each subscription, stored and updated in the mandate record during various stages in the lifetime of the subscription. This status flag is used to enforce aspects of the network protocol (e.g., prohibiting authorization requests if the recurring indicator process was not successfully completed). More specifically, the status flag indicates whether or not a recurring transaction, if received at that time, would be allowed or rejected for that subscription. When the SMN 130 receives the initial consent 164 of the user 102 (e.g., in MRES 162 of FIG. 1), this status flag is set to TRUE (e.g., in preparation for acceptance of the first transaction). After the first transaction has been approved by the issuer 140, this status flag is set to FALSE (e.g., thus prohibiting the next recurring transaction from being allowed until other steps are completed). For the next recurring transaction to be allowed, the status flag is reset to TRUE after the RIREQ 210 is received from the merchant 114, the notification message 220 is sent to the user 102, and an affirmative response is received for that message 220 (e.g., via express approval 222 or response timeout 226). The status flag is set back to FALSE after a recurring transaction is successfully authorized by the issuer 140, thus forcing the merchant system 114 to perform another successful RIREQ 210 for the next recurring transaction. As such, leaving this status flag to FALSE during the period between recurring transactions forces the merchant system 114 to successfully complete the RIREQ 210 and RIRES 212 process successfully (and receive an affirmative response). Accordingly, if the SMN 130 receives an authorization request for this subscription when the status flag is FALSE, the SMN 130 declines that transaction (e.g., via an authorization response message to the merchant system 114).

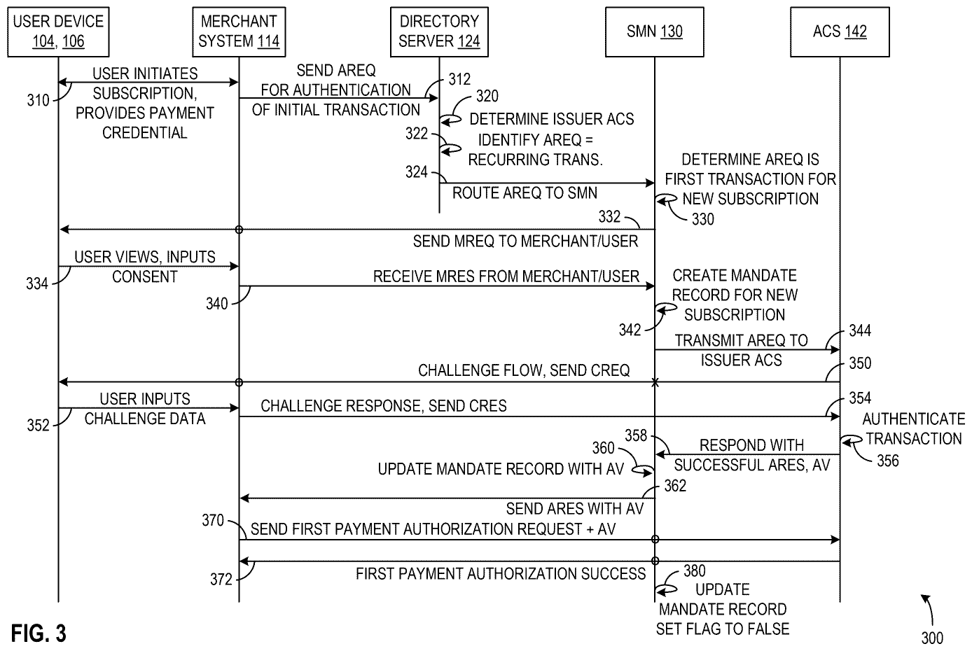

FIG. 3 is a sequence diagram illustrating operations for an example process 300 and network protocol for establishing a new subscription with the SMN 130. In examples, the operations shown in FIG. 3 are performed in the architecture of the system 100 shown in FIG. 1 and FIG. 2. The operations shown in FIG. 3 are performed as the user 102 establishes a new subscription with the merchant 110 and may be similar to the operations shown and described in relation to FIG. 1. In the example, at operation 310, the user 102 initiates a new subscription with the merchant 110, including providing payment credential information to the merchant system 114 (e.g., via the user computing device 104, the mobile device 106, or the like, collectively shown in FIG. 3 as “user device” 104, 106).

At operation 312, in the example, the merchant system 114 creates an authentication request message (e.g., AREQ 150) for an initial transaction in a series of recurring transactions for this new subscription. This AREQ 150 is initially sent to the directory server 124 and includes payment credential information, a transaction ID unique to this first transaction, and recurring payment data as described in FIG. 1 (e.g., transactionType=01, recurringIndicator=TRUE), as well as various other data to support the authentication of this transaction and the systems and methods described herein, such as a merchant ID of the merchant 110, the recurring frequency and the transaction amount for this subscription.

At operation 320, the directory server 124 determines the issuer 140 associated with the payment credential provided in the AREQ 150 and, more specifically, the ACS 142 of that issuer 140. At operation 322, the directory server 124 also parses the AREQ 150 and identifies that this AREQ 150 is a recurring transaction (e.g., based on recurringIndicator=TRUE). Accordingly, at operation 324, the directory server 124 routes the AREQ 150 to the SMN 130.

At operation 330, the SMN 130 receives the AREQ 150 and determines that this AREQ 150 is a first transaction for a new subscription (e.g., based on transactionType=01). In some examples, the SMN 130 may search the mandate DB 132 to verify that no mandate record already exists for this subscription (e.g., based on transaction ID, merchant ID, payment credential, user ID, or any combination thereof). In some examples, the SMN 130 generates a new CSID for this subscription. Accordingly, the SMN 130 is presumed to determine that this is a new subscription in this example. At operation 332, the SMN 130 generates a mandate request message (e.g., MREQ 160) and sends the MREQ 160 to the merchant system 114 and thus through to the user device 104, 106. As described in FIG. 1, the MREQ 160 includes subscription information for this new information that is displayed on the user device 104, 106, such as the recurring frequency and the transaction amount for the subscription (e.g., as parsed from the AREQ 150), as well as perhaps a first transaction amount (e.g., if different than the recurring transaction amount) and the CSID. At operation 334, the user 102 views the subscription data provided in the MREQ 160 and is presumed to consent to the establishment of this subscription (e.g., with consent 164).

At operation 340, the merchant system 114 sends a mandate response message (e.g., MRES 162) to the SMN 130 with the consent 164), and the MRES 162 is received by the SMN 130 for processing. At operation 342, the SMN 130 creates a new mandate record in the mandate DB 132 for this subscription (e.g., including CSID for this subscription, merchant ID of the merchant 110). At operation 344, the SMN 130 continues the authentication process for this first transaction by sending the AREQ 150 on to the issuer ACS 142 identified by the directory server 124 for this transaction.

In the example, the ACS 142 of the issuer 140 receives the AREQ 150 for this first transaction and evaluates whether or not the transaction will be authenticated or declined without a further challenge flow, or if a challenge flow will be performed before authentication is completed. In situations where this AREQ 150 is evaluated for a challenge flow, at operation 350, the ACS 142 sends a challenge request (e.g., CREQ 170) back to the merchant system 114 in response to this AREQ 150, and thus through to the user 102 for some additional user input. At operation 352, the user 102 inputs challenge data, and the merchant system 114 sends a challenge response (e.g., CRES 172) at operation 354. In this example, it is presumed that either the challenge flow of operations 350-354 was successful or the ACS 142 successfully authenticated the AREQ 150 without a challenge flow. As such, at operation 356, the ACS 142 authenticates this transaction, thereby generating an authentication value (e.g., AV 154) for this transaction and responding to the AREQ 150 with a successful authentication response (e.g., ARES 152) that includes the AV 154 at operation 358.

At operation 360, the SMN 130 receives the ARES 152 and updates the mandate record associated with this subscription based on the contents of the ARES 152. In cases of successful authentication, this update includes storing the AV 154 provided in the ARES 152 and setting the status flag to TRUE for this record (e.g., thereby preparing for allowance of the first transaction authorization, soon to be forthcoming). At operation 362, the SMN 130 sends the ARES 152 to the merchant system 114 with the AV 154.

At this stage of the initial subscription setup, the user 102 has been authenticated to use the payment credential for this first transaction, and the SMN 130 has set up a new mandate record for this subscription. As such, the SMN 130 is prepared to allow the first recurring transaction for this subscription to pass through the SMN 130. Accordingly, at operation 370, the merchant system 114 creates and sends a payment authorization request for this first transaction to the payment network 120. While not shown in FIG. 3, this authorization request may be sent to the directory server 124 and redirected to the SMN 130 similar to the AREQ 150. The SMN 130 verifies that the status flag for this subscription is set to TRUE and passes this authorization request through to the ACS 142 (all of which is presumed to be included in operation 370). At operation 372, the ACS 142 is presumed to successfully authorize this transaction and thus responds with a successful authorization response for this first transaction. The SMN 130 handles this successful authorization response during operation 372 and passes this successful response on to the merchant system 114. Additionally, at operation 380, the SMN 130 updates the status flag in the mandate record for this subscription to FALSE, thereby prohibiting any further recurring transactions to pass the SMN 130 for this subscription until a successful recurring indicator request (e.g., RIREQ 210) is performed.

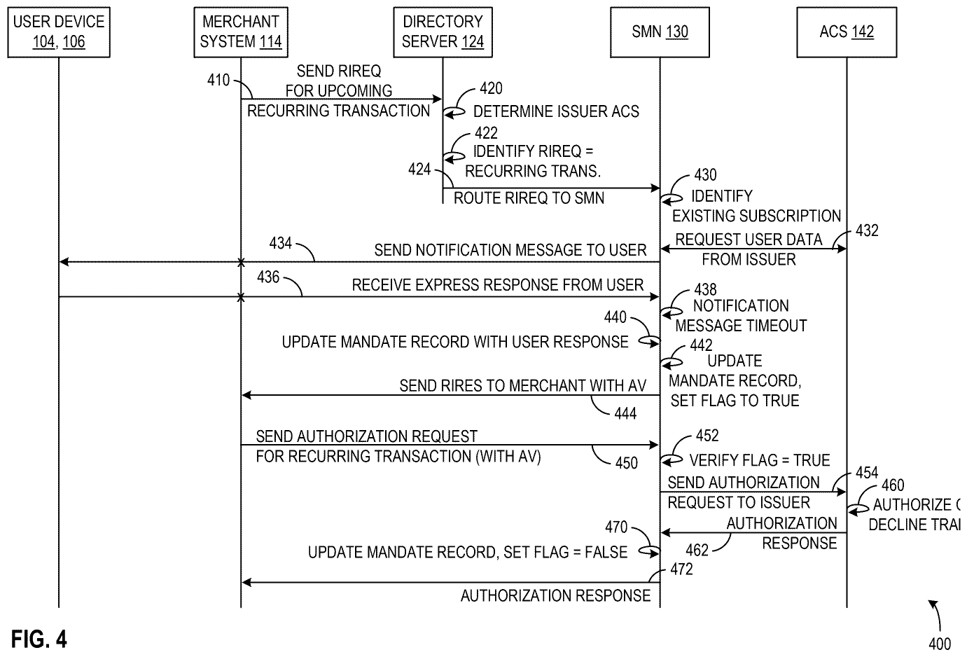

FIG. 4 is a sequence diagram illustrating operations for an example process 400 and network protocol for performing a transaction authorization for an existing subscription with the SMN 130. In examples, the operations shown in FIG. 4 are performed in the architecture of the system 100 shown in FIG. 1 and FIG. 2. The operations shown in FIG. 4 are performed as the merchant 110 submits a recurring transaction for the example subscription established in FIG. 3 and may be similar to the operations shown and described in relation to FIG. 2. In the example, it is presumed that the merchant system 114 has determined that it is nearing time to submit another recurring transaction for the user 102 in their subscription (e.g., 24 hours before the next recurring transaction is planned) and is preparing the SMN 130 in anticipation of performing a transaction authorization request for that upcoming recurring transaction. Further, it is presumed that the mandate record associated with this subscription, as stored in the mandate DB 132, has its status flag set to FALSE at the beginning of this recurring transaction process, thus prohibiting the processing of authorization requests under this subscription until certain preparatory steps are completed, as described herein (e.g., a successful RIREQ 210 and RIRES 212).

In the example, at operation 410, the merchant system 114 creates and sends a recurring indicator request (e.g., RIREQ 210) to the payment network 120. The RIREQ 210 includes the transaction ID of the first transaction in the subscription series and/or the CSID associated with the subscription (e.g., as established during the subscription setup described in FIG. 1 and FIG. 3) and recurring payment data as described in FIG. 2 (e.g., transactionType=02, recurringIndicator=TRUE), as well as various other data to support the authorization of this recurring transaction and the systems and methods described herein, such as a merchant ID of the merchant 110 and payment credential of the user 102. At operation 420, the directory server 124 determines the issuer 140 associated with the payment credential provided in the RIREQ 210 and, more specifically, the ACS 142 of that issuer 140. At operation 422, the directory server 124 also parses the RIREQ 210 and identifies that this RIREQ 210 is a recurring transaction (e.g., based on recurringIndicator =TRUE). Accordingly, at operation 424, the directory server 124 routes the RIREQ 210 to the SMN 130.

At operation 430, the SMN 130 receives the RIREQ 210 and identifies the existing subscription (e.g., the mandate record from the mandate DB 132) for this user 102. In examples, the SMN 130 uses one or more of the first transaction ID, the merchant ID, and/or the CSID included in the RIREQ 210 to identify the mandate record associated with this subscription. In some examples, the mandate record includes contact data for the user 102 associated with this subscription (e.g., email address, mobile phone number, or the like). In the example, the SMN 130 requests contact data for this user 102 from the issuer ACS 142 at operation 432 (e.g., identifying the user 102 based on the payment credential provided in the RIREQ 210).

At operation 434, the SMN 130 creates and transmits a notification message (e.g., notification message 220) to the user 102 using the contact data (e.g., via email message, SMS text message, app alert, or the like). In examples, this notification 220 includes text content identifying the subscription with the merchant 110 and that an upcoming recurring payment is coming due (e.g., including a transaction amount and/or transaction date for that anticipated transaction). Further, in the example, the notification 220 also provides user input options allowing the user 102 to reply to the notification 220 with an approval option (e.g., express approval 222) and a cancellation option (e.g., express cancel 224).

In the example shown in FIG. 4, one of two options are possible for the pending notification message 220. In some situations, as represented by operation 436, the user 102 responds to the notification message 220, either with an express accept 222 or an express cancel 224. In some situations, as represented by operation 438, the user 102 does not respond within a timeout period and the SMN 130 treats the message 220 with a response timeout 226 (e.g., after a timeout period elapses from the sending of the message 220, such as 24 hours after transmission). In this example, it is presumed that either the user 102 responds with an express accept 222 or allows the response timeout 226 to elapse, and thus this notification message 220 and upcoming recurring transaction is treated as approved by the user 102.

Accordingly, at operation 440, the SMN 130 updates the mandate record for this subscription with the response of the user 102 (e.g., express acceptance 222, reply timeout 226). Further, at operation 442, the SMN 130 also updates the mandate record to set the status flag to TRUE, thereby allowing a recurring transaction to be submitted against this subscription. At operation 444, the SMN 130 sends a recurring indicator response message (e.g., RIRES 212) to the merchant system 114 in response to the RIREQ 210. In the example, the SMN 130 looks up the AV 154 of this subscription from the mandate record and includes the AV 154 in the RIRES 212.

As such, at this stage, the SMN 130 has been prepared to accept a recurring transaction authorization request for this subscription and the merchant system 114 has been notified that this authorization request may proceed. At operation 450, the merchant system 114 prepares and transmits an authorization request for this next recurring transaction. In this example, the authorization request includes at least a transaction amount for this recurring transaction (e.g., the monthly charge amount), the AV 154 (e.g., allowing liability shift from merchant to issuer), the first transaction ID (e.g., allowing the SMN 130 to identify the subscription), the recurring transaction flags (e.g., transactionType=02, recurringIndicator=TRUE, identifying this authorization request as a recurring transaction associated with an existing subscription), as well as various other transaction data used to authorize this transaction. While not shown in FIG. 4, this authorization request is presumed to be sent through the directory server 124 and similarly redirected to the SMN 130.

In some examples, the ACS 142 or the SMN 130 may initiate a step-up challenge to the user 102 during authorization of this recurring transaction. For example, if the transaction amount for the pending authorization request is determined to be different than or greater than the consented amount (e.g., the transaction amount of the initial transaction) or above a threshold amount, then the ACS 142 or SMN 130 may perform a step-up challenge with the user 102 for this particular transaction. In some examples, this step-up challenge involves a biometric authentication (e.g., via mobile device 106), a knowledge based authentication (KBA), a transaction context verification (e.g., user contact via call, email, text message to confirm user authorization of this transaction), or the like.

At operation 452, the SMN 130 receives the authorization request, identifies the mandate record for this subscription, and verifies that the status flag for this subscription is currently set to TRUE. As such, the SMN 130 sends the authorization request on to the issuer ACS 142 at operation 454. The issuer ACS 142 processes the authorization request, either authorizing or declining this recurring transaction at operation 460 and responding to the authorization request with an authorization response at operation 462. At operation 464, the SMN 130 receives the authorization response, identifies that the authorization request was successfully authorized (e.g., the user 102 was charged for this recurring transaction), and thus the SMN 130 updates the mandate record for this subscription, changing the status flag back to FALSE at operation 470. At operation 472, the SMN 130 sends the authorization response to the merchant system 114, thereby completing this transaction.

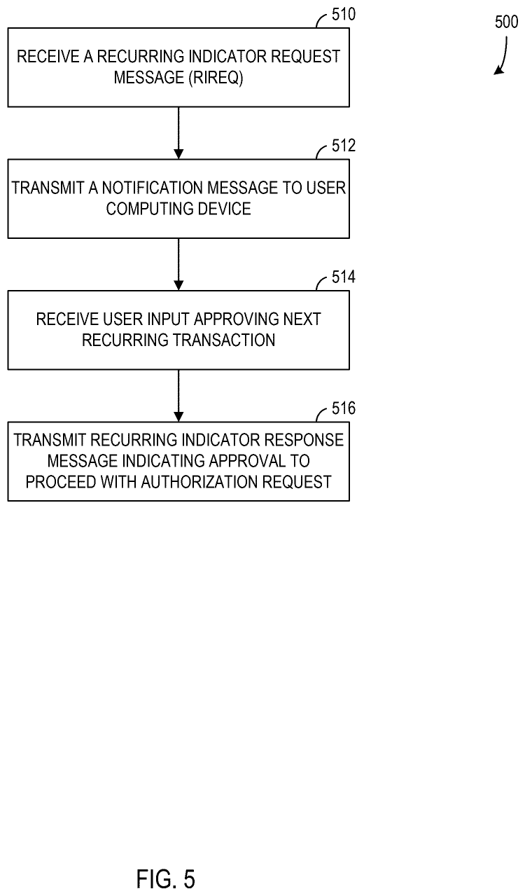

FIG. 5 is a flowchart of an exemplary method 500 for managing subscription services in a payment network. In some examples, the method 500 is performed by the SMN 130 shown in FIG. 1. In the example, at operation 510, the SMN 130 receives a recurring indicator request message (e.g., RIREQ 210) associated with a recurring transaction in a subscription, the recurring indicator request message being a request for approval to submit an authorization request for the subscription. At operation 512, the SMN 130 transmits a notification message (e.g., notification message 220) to a user computing device associated with the subscription (e.g., user computing device 104, mobile device 106), the notification message requesting user consent to process a next recurring transaction for the subscription. In some examples, the notification message provides a first option to expressly approve, a second option to expressly cancel, and a third option to not respond within a timeout period, the third option representing an implicit approval to proceed with the recurring transaction.

At operation 514, the SMN 130 receives first user input from the user computing device in response to the notification message, the first user input identifying an approval of a next recurring transaction (e.g., express approval 222). At operation 516, the SMN 130 transmits a recurring indicator response message (e.g., RIRES 212), the recurring indicator response message providing an indication of approval to proceed with submission of an authorization request for the next recurring transaction.

In some examples, the SMN 130 receives the authorization request for the next recurring transaction and approves submission of the authorization request for the recurring transaction based at least in part on the first user input, the approval including transmitting the authorization request to an issuer computing device associated with a payment credential provided in the authorization request. In some examples, the SMN 130, in response to receipt of the first user input, sets a status data element of a mandate record associated with the subscription to a value that allows recurring transactions to be submitted for this subscription and, upon receipt of a successful authorization response message associated with the authorization request, changes the status data element to a value that denies recurring transactions for this subscription. In some examples, the SMN 130 receives another authorization request associated with the subscription, determines that the status data element of the mandate record associated with the subscription is currently set to deny recurring transactions for this subscription, and denies the other transaction based on the determining.

In some examples, the SMN 130 receives, from an issuer computing device, an authorization value generated during authorization of a first recurring transaction for the subscription, stores the authorization value in a mandate record associated with the subscription, and adds the authorization value to the recurring indicator response message, thereby allowing inclusion of the authorization value in the authorization request for the first recurring transaction.

In some examples, the SMN 130 receives, from a merchant computing device, an authorization request that includes a first data element indicating the authorization request being a recurring transaction-type request and a second data element indicating the authorization request being a first message in a series for the subscription, transmits a mandate request message to the merchant computing device, thereby causing the merchant computing device to display recurring transaction data to a user establishing the subscription and prompting the user to provide second user input, the second user input indicating user approval to establish the subscription, receives a mandate response message from the merchant computing device indicating the user approval to establish the subscription, and creates a mandate record for the subscription, the mandate record representing the user approval to establish the subscription.

### Exemplary Operating Environment

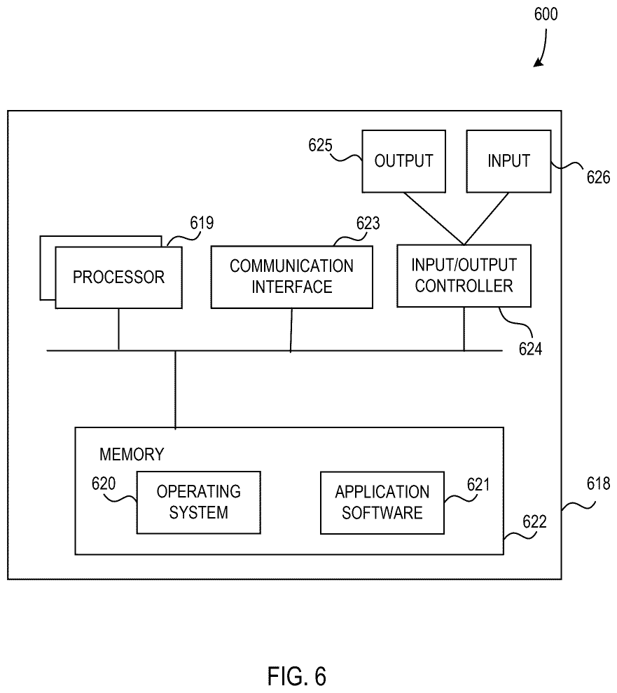

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 is a computing device, such as, but not limited to, the merchant system 114, the SMN 130, the user computing device 104, the mobile computing device 106, or the ACS 142 in FIG. 1.

The computing apparatus 618 comprises one or more processors 619 which can be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device.

In some examples, computer executable instructions are provided using any computer-readable medium or media accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 in other examples outputs data to devices other than the output device, e.g., a locally connected printing device. In some examples, a user provides input to the input device(s) 626 and/or receives output from the output device(s) 625.

The functionality described herein can be performed, at least in part, by one or more hardware logic components. The computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Additional Examples

In some examples, a subscription management network is provided. The subscription management network comprises: at least one processor; and at least one memory comprising computer-readable instructions, the at least one processor, the at least one memory and the computer-readable instructions configured to cause the at least one processor to: receive a first message associated with a recurring transaction in a subscription, the first message being received prior to receiving an authorization request for the recurring transaction, the first message being a request for approval to submit the authorization request for the recurring transaction; transmit a notification message to a user computing device associated with the subscription, the notification message identifying one or more of a merchant associated with the recurring transaction and a transaction amount of the recurring transaction; receive first user input from the user computing device in response to the notification message, the first user input identifying an approval of the recurring transaction; and transmit a second message in response to the first message, the second message providing an indication of approval to proceed with submission of the authorization request for the recurring transaction.

In some examples, a computer-implemented method for managing subscription services in a payment network is provided. The method comprises: receiving a recurring indicator request message associated with a recurring transaction in a subscription, the recurring indicator request message being a request for approval to submit an authorization request for the subscription; transmitting a notification message to a user computing device associated with the subscription, the notification message requesting user consent to process a next recurring transaction for the subscription; receiving first user input from the user computing device in response to the notification message, the first user input identifying an approval of a next recurring transaction; and transmitting a recurring indicator response message, the recurring indicator response message providing an indication of approval to proceed with submission of an authorization request for the next recurring transaction.

In some examples, a computer storage medium having computer-executable instructions is provided. Upon execution by a processor of a computer, the computer-executable instructions cause the processor to at least: receive a first message associated with a recurring transaction in a subscription, the first message being received prior to receiving an authorization request for the recurring transaction, the first message being a request for approval to submit the authorization request for the recurring transaction; transmit a notification message to a user computing device associated with the subscription, the notification message identifying one or more of a merchant associated with the recurring transaction and a transaction amount of the recurring transaction; receive first user input from the user computing device in response to the notification message, the first user input identifying an approval of the recurring transaction; and transmit a second message in response to the first message, the second message providing an indication of approval to proceed with submission of the authorization request for the recurring transaction.

Alternatively, or in addition to the other examples described herein, examples include any combination of the following:
receive a first message associated with a recurring transaction in a subscription;
the first message being received prior to receiving an authorization request for the recurring transaction;
the first message being a request for approval to submit the authorization request for the recurring transaction;
transmit a notification message to a user computing device associated with the subscription;
the notification message identifying one or more of a merchant associated with the recurring transaction and a transaction amount of the recurring transaction;
receive first user input from the user computing device in response to the notification message;
the first user input identifying an approval of the recurring transaction;
transmit a second message in response to the first message;
the second message providing an indication of approval to proceed with submission of the authorization request for the recurring transaction;
after transmission of the second message, receive the authorization request for the recurring transaction;
approve submission of the authorization request for the recurring transaction based at least in part on the first user input;
the approval including transmitting the authorization request to an issuer computing device associated with a payment credential provided in the authorization request;
in response to receipt of the first user input, set a status flag of a mandate record associated with the subscription to allow recurring transactions to be submitted for this subscription;
upon receipt of a successful authorization response message associated with the authorization request message, update the status flag to deny recurring transactions for this subscription;
receive another authorization request associated with the subscription;
determine that the status flag of the mandate record associated with the subscription is currently set to deny recurring transactions for this subscription;
deny the other transaction based on the determining;
receive, from an issuer computing device, an authorization value generated during authorization of a first recurring transaction for the subscription; store the authorization value in a mandate record associated with the subscription;
add the authorization value to the second message, thereby allowing inclusion of the authorization value in the authorization request for the recurring transaction;
the notification message provides a first option to expressly approve, a second option to expressly cancel, and a third option to not respond within a timeout period, the third option representing an implicit approval to proceed with the recurring transaction;
receive, from a merchant computing device, an authentication request that includes a first data element indicating the authentication request being a recurring transaction-type request and a second data element indicating the authentication request being a first message in a series for the subscription;
transmit a mandate request message to the merchant computing device, thereby causing the merchant computing device to display recurring transaction data to a user establishing the subscription and prompting the user to provide second user input, the second user input indicating user approval to establish the subscription;
receive a mandate response message from the merchant computing device indicating the user approval to establish the subscription; create a mandate record for the subscription, the mandate record including at least a transaction identifier associated with the authorization request;
receiving a recurring indicator request message associated with a recurring transaction in a subscription, the recurring indicator request message being a request for approval to submit an authorization request for the subscription;
transmitting a notification message to a user computing device associated with the subscription, the notification message requesting user consent to process a next recurring transaction for the subscription;
receiving first user input from the user computing device in response to the notification message, the first user input identifying an approval of a next recurring transaction;
transmitting a recurring indicator response message, the recurring indicator response message providing an indication of approval to proceed with submission of an authorization request for the next recurring transaction;
receiving the authorization request for the next recurring transaction;
approving submission of the authorization request for the recurring transaction based at least in part on the first user input, the approval including transmitting the authorization request to an issuer computing device associated with a payment credential provided in the authorization request;
in response to receipt of the first user input, setting a status data element of a mandate record associated with the subscription to a value that allows recurring transactions to be submitted for this subscription;
upon receipt of a successful authorization response message associated with the authorization request, changing the status data element to a value that denies recurring transactions for this subscription;
receiving another authorization request associated with the subscription;
determining that the status data element of the mandate record associated with the subscription is currently set to deny recurring transactions for this subscription;
denying the other transaction based on the determining;
receiving, from an issuer computing device, an authorization value generated during authorization of a first recurring transaction for the subscription;
storing the authorization value in a mandate record associated with the subscription;
adding the authorization value to the recurring indicator response message, thereby allowing inclusion of the authorization value in the authorization request for the first recurring transaction;
the notification message provides a first option to expressly approve, a second option to expressly cancel, and a third option to not respond within a timeout period, the third option representing an implicit approval to proceed with the recurring transaction;
receiving, from a merchant computing device, an authentication request that includes a first data element indicating the authentication request being a recurring transaction-type request and a second data element indicating the authentication request being a first message in a series for the subscription;
transmitting a mandate request message to the merchant computing device, thereby causing the merchant computing device to display recurring transaction data to a user establishing the subscription and prompting the user to provide second user input, the second user input indicating user approval to establish the subscription;
receiving a mandate response message from the merchant computing device indicating the user approval to establish the subscription; and
creating a mandate record for the subscription, the mandate record representing the user approval to establish the subscription.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for managing subscription services in a payment network; receiving a recurring indicator request message associated with a recurring transaction in a subscription, the recurring indicator request message being a request for approval to submit an authorization request for the subscription; transmitting a notification message to a user computing device associated with the subscription, the notification message requesting user consent to process a next recurring transaction for the subscription; receiving first user input from the user computing device in response to the notification message, the first user input identifying an approval of a next recurring transaction; and transmitting a recurring indicator response message, the recurring indicator response message providing an indication of approval to proceed with submission of an authorization request for the next recurring transaction

At least a portion of the functionality of the various elements in FIG. 1 to FIG. 6 can be performed by other elements in FIG. 1 to FIG. 6, or an entity (e.g., processor, web service, server, application program, computing device, etc.) not shown in FIG. 1 to FIG. 6.

In some examples, the operations illustrated in FIG. 1 and FIG. 5 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium has instructions recorded thereon which when executed by a computer device cause the computer device to cooperate in performing a method for assisting in a renovation of a room, the method comprising: receiving a first image of a room, the first image of the room being a digital image of the room prior to a planned renovation; inputting the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receiving, from the generative ML model, a second image of the room, the second image being the renovated room image; inputting the second image to a second ML model, the second ML model being configured to identify objects that appear in an input image and output a list of objects; and transmitting the second image and the list of objects to a user computing device, the list of objects being displayed as a list of items to upgrade the room to appear as shown in the second image.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A payment network comprising:
a subscription management network; and
a directory server configured to inspect a first message associated with a recurring transaction in a subscription for a presence of a recurring indicator flag set to TRUE; and, in response to detecting the recurring indicator flag set to TRUE, route the first message to the subscription management network and otherwise route the first message to an issuer access control server;
wherein the subscription management network comprises:
at least one processor; and
at least one memory comprising computer-readable instructions, the at least one processor, the at least one memory and the computer-readable instructions configured to cause the at least one processor to:
receive, from a merchant computing device, a recurring indicator request message associated with the recurring transaction in the subscription, the recurring indicator request message being received prior to receiving an authorization request for the recurring transaction, the recurring indicator request message being a request for approval to submit the authorization request for the recurring transaction;
transmit a notification message to a user computing device associated with the subscription, the notification message requesting a user approval to process the recurring transaction for the subscription;
receive a first user input from the user computing device in response to the notification message, the first user input identifying an approval of the recurring transaction; and
transmit, to the merchant computing device, a recurring indicator response message in response to receiving the first user input, the recurring indicator response message providing an indication of approval to proceed with submission of the authorization request for the recurring transaction.

2. The subscription management network of claim 1, wherein the computer-readable instructions are further configured to cause the at least one processor to:
after transmission of the recurring indicator response message, receive the authorization request for the recurring transaction; and
approve the submission of the authorization request for the recurring transaction based at least in part on the first user input, the approval including transmitting the authorization request to an issuer computing device associated with a payment credential provided in the authorization request.

3. The subscription management network of claim 2, wherein the computer-readable instructions are further configured to cause the at least one processor to:
in response to receipt of the first user input, set a status flag of a mandate record associated with the subscription to allow recurring transactions to be submitted for this subscription; and
upon receipt of a successful authorization response message associated with the authorization request, update the status flag to deny recurring transactions for this subscription.

4. The subscription management network of claim 3, wherein the computer-readable instructions are further configured to cause the at least one processor to:
receive another authorization request associated with the subscription;
determine that the status flag of the mandate record associated with the subscription is currently set to deny recurring transactions for this subscription; and
deny a further transaction for the subscription based on the determining.

5. The subscription management network of claim 1, wherein the computer-readable instructions are further configured to cause the at least one processor to:
receive, from an issuer computing device, an authorization value generated during authorization of a first recurring transaction for the subscription;
store the authorization value in a mandate record associated with the subscription; and
add the authorization value to the recurring indicator response message, thereby allowing inclusion of the authorization value in the authorization request for the first recurring transaction.

6. The subscription management network of claim 1, wherein the notification message provides a first option to expressly approve, a second option to expressly cancel, and a third option to not respond within a timeout period, the third option representing an implicit approval to proceed with the recurring transaction.

7. The subscription management network of claim 1, wherein the computer-readable instructions are further configured to cause the at least one processor to:
receive, from a merchant computing device, an authentication request that includes a first data element indicating the authentication request is a recurring transaction-type request and a second data element indicating the authorization request is a first message in a series for the subscription;
transmit a mandate request message to the merchant computing device, thereby causing the merchant computing device to display recurring transaction data to a user establishing the subscription and prompting the user to provide a second user input, the second user input indicating a user approval to establish the subscription;
receive a mandate response message from the merchant computing device indicating the user approval to establish the subscription; and
create a mandate record for the subscription, the mandate record including at least a transaction identifier associated with the authentication request.

8. A computer-implemented method for managing subscription services in a payment network that comprises a subscription management network and a directory server, the method comprising:
inspecting, by the directory server, a first message associated with a recurring transaction in a subscription for a presence of a recurring indicator flag set to TRUE;
routing, by the directory server and in response to detecting the recurring indicator flag set to TRUE, the first message to the subscription management network and otherwise routing the first message to an issuer access control server;
receiving, by the subscription management network and from a merchant computing device, a recurring indicator request message associated with the recurring transaction in the subscription, the recurring indicator request message being a request for approval to submit an authorization request for the recurring transaction;
transmitting, by the subscription management network, a notification message to a user computing device associated with the subscription, the notification message requesting a user approval to process a next recurring transaction for the subscription;
receiving, by the subscription management network, a first user input from the user computing device in response to the notification message, the first user input identifying the user approval to process the next recurring transaction for the subscription; and
transmitting, by the subscription management network and to the merchant computing device, a recurring indicator response message, the recurring indicator response message providing an indication of approval to proceed with submission of the authorization request for the recurring transaction.

9. The method of claim 8, further comprising:
receiving the authorization request for the next recurring transaction for the subscription; and
approving submission of the authorization request for the next recurring transaction for the subscription based at least in part on the first user input, the approval including transmitting the authorization request to an issuer computing device associated with a payment credential provided in the authorization request.

10. The method of claim 9, further comprising:
in response to receipt of the first user input, setting a status data element of a mandate record associated with the subscription to a value that allows recurring transactions to be submitted for this subscription; and
upon receipt of a successful authorization response message associated with the authorization request, changing the status data element to a value that denies recurring transactions for this subscription.

11. The method of claim 10, further comprising:
receiving another authorization request associated with the subscription;
determining that the status data element of the mandate record associated with the subscription is currently set to deny recurring transactions for this subscription; and
denying a further transaction for the subscription based on the determining.

12. The method of claim 8, further comprising:
receiving, from an issuer computing device, an authorization value generated during authorization of a first recurring transaction for the subscription;
storing the authorization value in a mandate record associated with the subscription; and
adding the authorization value to the recurring indicator response message, thereby allowing inclusion of the authorization value in the authorization request for the first recurring transaction.

13. The method of claim 8, wherein the notification message provides a first option to expressly approve, a second option to expressly cancel, and a third option to not respond within a timeout period, the third option representing an implicit approval to proceed with the recurring transaction.

14. The method of claim 8, further comprising:
receiving, from a merchant computing device, an authentication request that includes a first data element indicating the authentication request being a recurring transaction-type request and a second data element indicating the authentication request being a first message in a series for the subscription;
transmitting a mandate request message to the merchant computing device, thereby causing the merchant computing device to display recurring transaction data to a user establishing the subscription and prompting the user to provide second user input, the second user input indicating user approval to establish the subscription;
receiving a mandate response message from the merchant computing device indicating the user approval to establish the subscription; and
creating a mandate record for the subscription, the mandate record representing the user approval to establish the subscription.

15. A non-transitory computer storage medium having computer-executable instructions that, upon execution by one or more processors, cause the one or more processors to perform a method for managing subscription services in a payment network that comprises a subscription management network and a directory server, the method comprising:
inspecting, by the directory server, a first message associated with a recurring transaction in a subscription for a presence of a recurring indicator flag set to TRUE;
routing, by the directory server and in response to detecting the recurring indicator flag set to TRUE, the first message to the subscription management network and otherwise routing the first message to an issuer access control server;
receiving, by the subscription management network and from a merchant computing device, a recurring indicator request message associated with the recurring transaction in the subscription, the recurring indicator request message being received prior to receiving an authorization request for the recurring transaction, the recurring indicator request message being a request for approval to submit the authorization request for the recurring transaction;
transmitting a notification message to a user computing device associated with the subscription, the notification message requesting a user approval to process the recurring transaction for the subscription;
receiving a first user input from the user computing device in response to the notification message, the first user input identifying an approval of the recurring transaction; and
transmitting, to the merchant computing device, a recurring indicator response message in response to receiving the first user input, the recurring indicator response message providing an indication of approval to proceed with submission of the authorization request for the recurring transaction.

16. The non-transitory computer storage medium of claim 15, wherein the method further comprises:
after transmission of the recurring indicator response message, receiving the authorization request for the recurring transaction; and
approving submission of the authorization request for the recurring transaction based at least in part on the first user input, the approval including transmitting the authorization request to an issuer computing device associated with a payment credential provided in the authorization request.

17. The non-transitory computer storage medium of claim 16, wherein the method comprises:
in response to receipt of the first user input, setting a status flag of a mandate record associated with the subscription to allow recurring transactions to be submitted for this subscription;
upon receipt of a successful authorization response message associated with the authorization request, updating the status flag to deny recurring transactions for this subscription;
receiving another authorization request associated with the subscription;
determining that the status flag of the mandate record associated with the subscription is currently set to deny recurring transactions for this subscription; and
denying a further transaction for the subscription based on the determining.

18. The non-transitory computer storage medium of claim 15, wherein method comprises:
receiving, from an issuer computing device, an authorization value generated during authorization of a first recurring transaction for the subscription;
storing the authorization value in a mandate record associated with the subscription; and
adding the authorization value to the recurring indicator response message, thereby allowing inclusion of the authorization value in the authorization request for the recurring transaction.

19. The non-transitory computer storage medium of claim 15, wherein the notification message provides a first option to expressly approve, a second option to expressly cancel, and a third option to not respond within a timeout period, the third option representing an implicit approval to proceed with the recurring transaction.

20. The non-transitory computer storage medium of claim 15, wherein the method comprises:
receiving, from a merchant computing device, an authentication request that includes a first data element indicating the authentication request being a recurring transaction-type request and a second data element indicating the authentication request being a first message in a series for the subscription;
transmitting a mandate request message to the merchant computing device, thereby causing the merchant computing device to display recurring transaction data to a user establishing the subscription and prompting the user to provide second user input, the second user input indicating a user approval to establish the subscription;
receiving a mandate response message from the merchant computing device indicating the user approval to establish the subscription; and
creating a mandate record for the subscription, the mandate record including at least a transaction identifier associated with the authentication request.
